(19) United States
(12) Patent Application Publication
(10) Pub. No.: US 2026/0044054 A1
(43) Pub. Date: Feb. 12, 2026

(54) BACK-SUPPORT SOFTBOX AND PHOTOGRAPHIC AUXILIARY DEVICE

(71) Applicant: Shenzhen Nice Photographic Equipment Co., Ltd, Shenzhen (CN)

(72) Inventor: Guoyu Que, Shenzhen (CN)

(21) Appl. No.: 19/204,593

(22) Filed: May 11, 2025

(30) Foreign Application Priority Data
Aug. 8, 2024 (CN) 202421920646.7

(51) Int. Cl. G03B 15/05

(52) U.S. Cl. CPC G03B 15/05; G03B 2215/0528; G03B 2215/0567

(57) ABSTRACT

Disclosed are a back-support softbox and a photographic auxiliary device. The back-support softbox has an expanded state and a folded state and includes a frame, a flexible reflective fabric, a plurality of light-emitting components and a support rod. The frame includes a plurality of first rods and an upper wheel. The plurality of first rods are arranged radially from the upper wheel as a center. The flexible reflective fabric is attached to the plurality of first rods. In the expanded state, the reflective fabric is stretched to form a dome-shaped structure. The plurality of light-emitting components are provided on an inner surface of the reflective fabric. One end of the support rod is connected to the frame, and an other end of the support rod extends away from a light-emitting opening of the dome-shaped structure to an outside of the dome-shaped structure.

### CROSS-REFERENCE TO RELATED APPLICATIONS

The present disclosure claims priority of Chinese Utility Model No. CN202421920646.7, filed on Aug. 8, 2024, the entire contents of which are hereby incorporated by reference.

### TECHNICAL FIELD

The present disclosure relates to the technical field of photographic equipment, and in particular to a back-support softbox and a photographic auxiliary device.

### BACKGROUND

When taking photographs indoors, a softbox is typically used to ensure sufficient brightness and soft lighting. The conventional umbrella-type softbox is deployed in a manner similar to that of ordinary umbrellas, and generally includes a support rod 400, a reflective fabric 200, a frame 100, and a plurality of light-emitting components. In consideration of the varying heights of photographic subjects, the umbrella-type softbox is often used in conjunction with a stand 500 to adjust the lighting height. As shown in FIG. 1, the light-emitting component is arranged on an inner surface of the reflective fabric 200. In the expanded state, one end of the support rod 400 is connected to the frame 100, and the other end extends toward the inner surface. When the light-emitting component is in operation, the softbox emits light. However, due to the support rod 400 and the stand 500, part of the light emitted from the softbox is blocked, resulting in shadows on the subject or person being photographed and a certain degree of light loss. Therefore, further improvement is needed.

### SUMMARY

In order to achieve the objective mentioned above, the present disclosure provides a back-support softbox having an expanded state and a folded state. The back-support softbox includes:
a foldable frame, including a plurality of first rods, a plurality of second rods, an upper wheel, and a lower wheel, wherein each first rod has a fixed end and a free end, and the fixed end is hinged to the upper wheel; and wherein the plurality of second rods are provided in one-to-one correspondence with the plurality of first rods, one end of each second rod is hinged to a corresponding first rod, and an other end of each second rod is hinged to the lower wheel;
a flexible reflective fabric, having an inner surface and an outer surface and being attached to the plurality of first rods, wherein in the expanded state, the reflective fabric is stretched to form a dome-shaped structure;
a plurality of light-emitting components, provided on the inner surface of the reflective fabric; and
a support rod, one end of the support rod being fixedly connected to the lower wheel, an other end of the support rod passing through the upper wheel and extending to an outside of the dome-shaped structure,

When the back-support softbox is transformed from the folded state to the expanded state, the upper wheel and the lower wheel move toward each other, and the plurality of first rods and the plurality of second rods rotate away from the support rod; and when the back-support softbox is transformed from the expanded state to the folded state, the upper wheel and the lower wheel move away from each other, and the plurality of first rods and the plurality of second rods rotate toward the support rod.

The following also provides several optional approaches, which do not constitute additional limitations to the aforementioned overall solution, but rather serve as further supplements or preferences. In the absence of technical or logical contradictions, each optional approach may be individually combined with the aforementioned overall solution, or multiple optional approaches may be combined with each other.

In some embodiments, each light-emitting component includes a substrate and a plurality of LED beads mounted on the substrate.

In some embodiments, each substrate is strip-shaped and extends in a radial direction of the back-support softbox.

In some embodiments, each two adjacent first rods are formed with a fan-shaped region therebetween, and the fan-shaped region is provided with at least one of the plurality of light-emitting components.

In some embodiments, the substrate is provided with a driving power source.

In some embodiments, the back-support softbox further includes a plurality of protective covers, wherein each driving power source is cover by one of the plurality of protective covers.

In some embodiments, a plug is provided on the outside of the dome-shaped structure, and the plug is electrically connected to the plurality of light-emitting components.

In some embodiments, a switch is provided on a wire connecting the plug and the plurality of light-emitting components.

In some embodiments, a locking member is provided on the support rod for locking the frame to maintain the back-support softbox in the expanded state.

In some embodiments, a limiting member is provided on the support rod for restricting movement of the upper wheel to prevent the dome-shaped structure from over-expanding.

In some embodiments, a gripping member is provided at an end of the support rod.

In some embodiments, the back-support softbox further includes a connecting base mounted on the support rod.

In some embodiments, the back-support softbox further includes a diffusion cloth or a grid mounted at an opening of the dome-shaped structure.

In some embodiments, the reflective fabric includes a central area and a peripheral area surrounding the central area, the central area has a double-layered structure, and a wire connected to the plurality of light-emitting components is hidden within an interlayer of the double-layered structure.

In some embodiments, the back-support softbox has a central axis, and the support rod is arranged along the central axis.

The present disclosure further provides a softbox, including:
a frame, including an upper wheel and a plurality of first rods, the plurality of first rods being arranged radially from the upper wheel as a center;
a reflective fabric, the reflective fabric being attached to the plurality of first rods and stretched to form a dome-shaped structure, the dome-shaped structure having an inner surface and an outer surface;
a plurality of light-emitting components, provided on the inner surface of the dome-shaped structure; and
a support rod, wherein one end of the support rod is connected to the frame, and an other end of the support rod extends away from a light-emitting opening of the dome-shaped structure to an outside of the dome-shaped structure.

In some embodiments, each first rod has a fixed end and a free end, the fixed end is hinged to the upper wheel, and the free end is away from the upper wheel. The frame further includes a lower wheel and a plurality of second rods, the one end of the support rod is connected to the lower wheel, and the other end of the support rod passes through the upper wheel. The plurality of second rods are provided in one-to-one correspondence with the plurality of first rods, one end of each second rod is hinged to a corresponding first rod, and an other end of each second rod is connected to the lower wheel.

The present disclosure further provides a photographic auxiliary device, including a stand and the above-mentioned softbox mounted on the stand. The support rod is connected to the stand.

In some embodiments, the support rod is arranged horizontally, and a back side of a light-emitting opening of the dome-shaped structure faces the stand.

In some embodiments, the support rod is provided with a connecting base for connecting to the stand, and the connecting base is slidable relative to the support rod.

In the back-support softbox provided by the present disclosure, one end of the support rod is connected to the frame, while the other end of the support rod extends away from the light-emitting opening of the dome-shaped structure to an outside of the dome-shaped structure, thereby preventing obstruction of light emission during operation and facilitating easier installation.

### BRIEF DESCRIPTION OF DRAWINGS

FIG. 1 is a schematic structural view of a softbox in the prior art;

FIG. 2 is a schematic structural view of a photographic auxiliary device according to an embodiment of the present disclosure;

FIG. 3 is an orthographic view of an inner surface of a back-support softbox in FIG. 2 in an expanded state;

FIG. 4 is a schematic structural view of the inner surface of the back-support softbox in FIG. 3 from another perspective;

FIG. 5 is an enlarged view of a portion B in FIG. 4;

FIG. 6 is a schematic structural view of a frame of the back-support softbox according to an embodiment of the present disclosure, in which the frame is in the expanded state;

FIG. 7 is a schematic structural view of an outer surface of the back-support softbox according to an embodiment of the present disclosure;

FIG. 8 is a schematic structural view of the back-support softbox according to an embodiment of the present disclosure, in which the back-support softbox is in a folded state;

FIG. 9 is a schematic structural view of a softbox according to an embodiment of the present disclosure;

FIG. 10 is a schematic structural view of the softbox in FIG. 9 from another perspective;

FIG. 11 is a schematic structural view of an upper wheel, a lower wheel and a support rod of the back-support softbox according to an embodiment of the present disclosure;

FIG. 12 is a schematic partial view of the back-support softbox according to an embodiment of the present disclosure, illustrating connection of two adjacent fan-shaped regions;

FIG. 13 is a schematic expanded view of a portion of the back-support softbox according to an embodiment of the present disclosure, illustrating an inner layer and an outer layer of the softbox in a center area;

FIG. 14 is a schematic partial view of the back-support softbox according to an embodiment of the present disclosure, illustrating a part of the inner layer is connected to a plurality of first rods, and another part of the inner layer is detached from a plurality of first rods;

FIG. 15 is a schematic structural view of a light-emitting component of the back-support softbox according to an embodiment of the present disclosure, without a protective cover;

FIG. 16 is a schematic structural view of a light-emitting component of the back-support softbox according to an embodiment of the present disclosure, with a protective cover;

FIG. 17 is a schematic structural view of a part of the softbox according to an embodiment of the present disclosure, which is installed with a diffusion cloth; and

FIG. 18 is a schematic connecting view of a connecting base and a support rod of the back-support softbox according to an embodiment of the present disclosure.

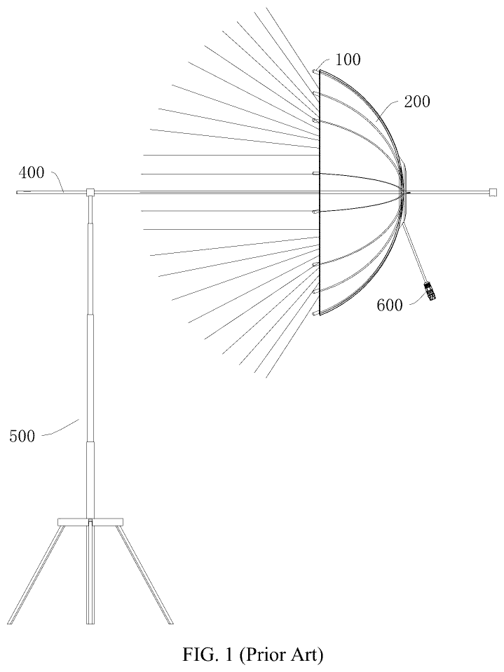

The reference signs in the drawings are explained as follows:
100. frame; 110. first rod; 111. fixed end; 112. free end; 120. second rod; 130. upper wheel; 131. through hole; 132. sleeve; 133. unlocking member; 140. lower wheel;
200. reflective fabric; 201. fan-shaped unit; 202. overlapping edge; 210. inner surface; 220. outer surface; 230. fixing sleeve; 240. central area; 241. inner layer; 242. outer layer; 243. perforation; 250. peripheral area;
300. light-emitting component; 310. light strip; 311. substrate; 312. LED bead; 313. driving power source; 314. first wire; 320. protective cover;
400. support rod; 410. locking member; 420. limiting member; 500. stand; 600. plug; 610. second wire; 620. switch;
700. connecting base; 710. first part; 711. coupling hole; 712. first latching member; 720. second part; 722. second latching member; 730. third latching member; 800. diffusion cloth.

### DESCRIPTION OF EMBODIMENTS

The technical solutions of the embodiments of the present disclosure will be clearly and completely described below with reference to the accompanying drawings. It is evident that the described embodiments are only part of the embodiments of the present disclosure, and not all of them. Based on the embodiments of the present disclosure, all other embodiments obtained by those skilled in the art without creative effort shall fall within the protection scope of the present disclosure.

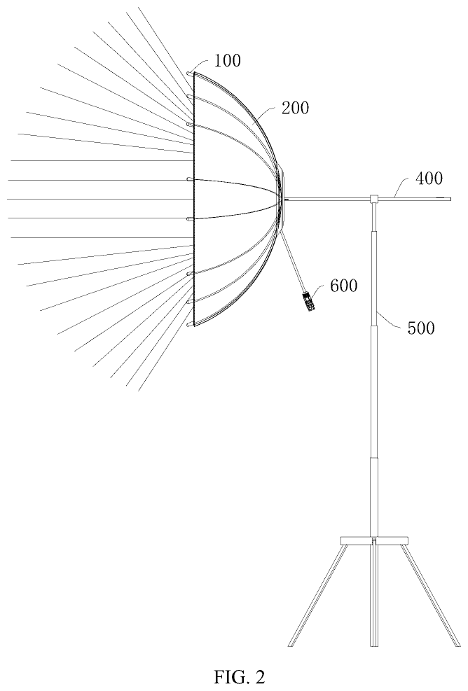

Referring to FIGS. 2 to 8, in an embodiment, the present disclosure provides a back-support softbox, which has an expanded state and a folded state. The back-support softbox includes a foldable frame 100, a flexible reflective fabric 200, a plurality of light-emitting components 300, and a support rod 400.

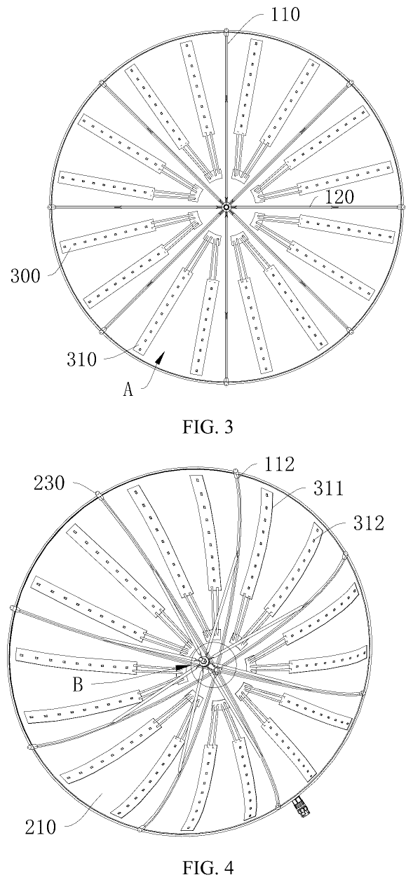

As shown in FIGS. 3 to 6, the frame 100 includes a plurality of first rods 110, a plurality of second rods 120, an upper wheel 130, and a lower wheel 140. The plurality of first rods 110 are arranged radially from the upper wheel 130 as a center. The number of first rods 110 may be adaptively selected based on requirements. For example, in the illustrated embodiment, eight first rods 110 are evenly arranged along the circumferential direction.

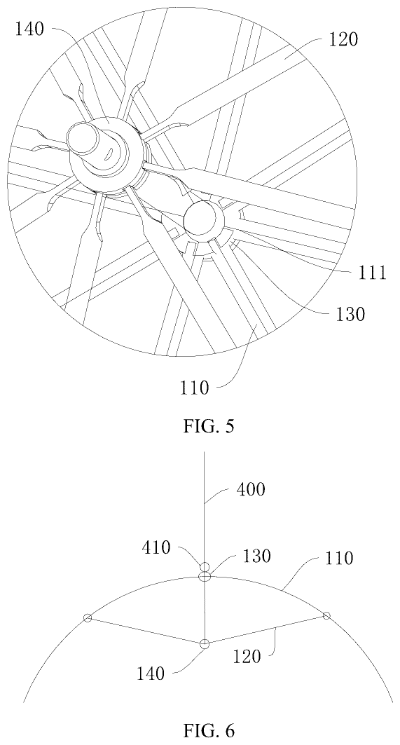

As shown in FIGS. 4 and 5, each first rod 110 has a fixed end 111 and a free end 112. The fixed end 111 is hinged to the upper wheel 130, and each first rod 110 extends radially such that the free end 112 is away from the upper wheel 130.

As shown in FIG. 6, the number of second rods 120 is the same as the number of first rods 110, and the plurality of second rods and the plurality of first rods are arranged in a one-to-one correspondence. For easier understanding, referring to FIG. 3, which is an orthographic view of the frame 100, each second rod 120 is aligned with a first rod 110 along the same straight line. Accordingly, eight second rods 120 are provided.

Further referring to FIG. 6, one end of each second rod 120 is hinged to a corresponding first rod 110, the hinge point is located close to the middle of the first rod 110 (which may also be adaptively selected according to needs), and the other end of each second rod 120 is hinged to the lower wheel 140.

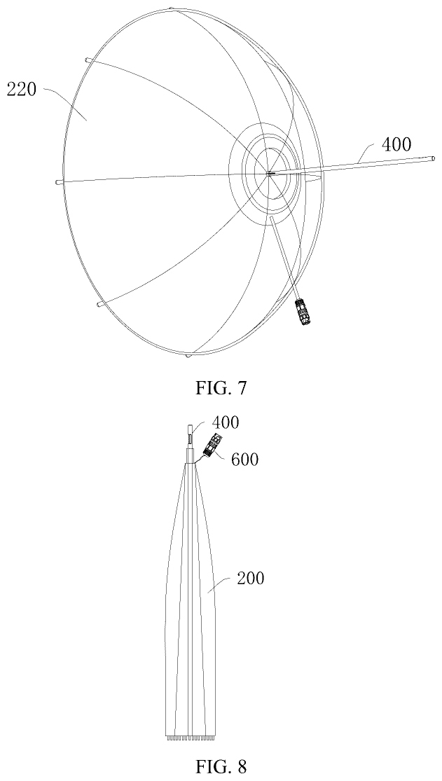

As shown in FIGS. 4 and 7, the flexible reflective fabric 200 has an inner surface 210 and an outer surface 220 and the reflective fabric 200 is attached to the plurality of first rods 110. In the expanded state, the reflective fabric 200 is stretched to form a dome-shaped structure, generally resembling an umbrella. As shown in FIG. 5, to facilitate fixing with the free ends 112 of the first rods 110, the edge of the reflective fabric 200 is provided with fixing sleeves 230 for mating and securing with the free ends 112.

As shown in FIGS. 3, 4, and 6, the plurality of light-emitting components 300 are arranged on the inner surface 210 of the reflective fabric 200 (i.e., the dome-shaped structure), and the support rod 400 is arranged along the central axis. One end of the support rod 400 is fixedly connected to the lower wheel 140, and the other end of the support rod 400 passes through the upper wheel 130 and extends to the outside of the dome-shaped structure. That is, when the plurality of light-emitting components 300 are operating, the support rod 400 is located on the back side of the reflective fabric 200, so the emitted light is not obstructed, improving usability.

When expanding the back-support softbox, the upper wheel 130 and the lower wheel 140 move close to each other, and the first rods 110 and second rods 120 rotate away from the central axis (i.e., the support rod); and when folding the back-support softbox, the upper wheel 130 and lower wheel 140 move away from each other, and the first rods 110 and second rods 120 rotate toward the central axis. Thus, when the frame is folded, all the first rods 110 and second rods 120 are synchronously expanded or folded, improving the deployment efficiency of the softbox during use.

Referring to FIGS. 3 to 5, the light-emitting components 300 are light strips 310. Each light strip 310 includes a substrate 311 and a plurality of LED beads 312 mounted on the substrate 311. Preferably, the substrate 311 is a deformable aluminum base plate so that the light strips 310 can fully conform to the reflective fabric 200. Alternatively, the light strips 310 may use FPC (flexible printed circuit) boards, which can also fully conform to the reflective fabric 200. In this embodiment, the substrate 311 is strip-shaped and extends in a radial direction of the back-support softbox. Each substrate 311 is provided with nine LED beads 312, which are evenly spaced in the length direction to ensure uniform light emission.

A fan-shaped region is formed between each two adjacent first rods 110 (as shown in A in FIG. 3), and each fan-shaped region is provided with two light strips 310. Preferably, the included angle between the two light strips 310 in each fan-shaped region is between 15° and 35°. In this embodiment, the included angle between the two light strips 310 in each fan-shaped region is 21°, and the included angle between two adjacent light strips 310 located in two adjacent fan-shaped regions is 24°.

As shown in FIGS. 7 and 8, to facilitate lighting, a plug 600 electrically connected to all the light strips 310 is provided on the outside of the dome-shaped structure. Thus, when the softbox is to be used, the user only needs to insert the plug 600 into a power source to enable all the light strips 310 to emit light simultaneously.

Referring to FIG. 6, a locking member 410 is provided on the support rod 400 for locking the frame 100 to maintain the back-support softbox in the expanded state. For example, in the expanded state shown in the figure, the locking member 410 can be disposed on the outside of the dome-shaped structure and adjacent to the upper wheel 130. In some embodiments, the specific structure of the locking member 410 is not particularly limited, as long as it can keep the frame 100 in the expanded state.

Referring to FIG. 2, the present disclosure also provides a photographic auxiliary device, including a stand 500 and a back-support softbox mounted on the stand 500. The support rod 400 in the back-support softbox is connected to the top of the stand 500. The support rod 400 is the same as described above. When the support rod 400 is used in combination with the stand 500, the height and position of the back-support softbox can be adjusted according to actual needs.

In one embodiment, the support rod 400 is arranged horizontally, and the back side of the light-emitting opening of the dome-shaped structure faces the stand 500. This design avoids the support rod 400 and the stand 500 from blocking light when the softbox is in use, thereby making it more convenient in practice.

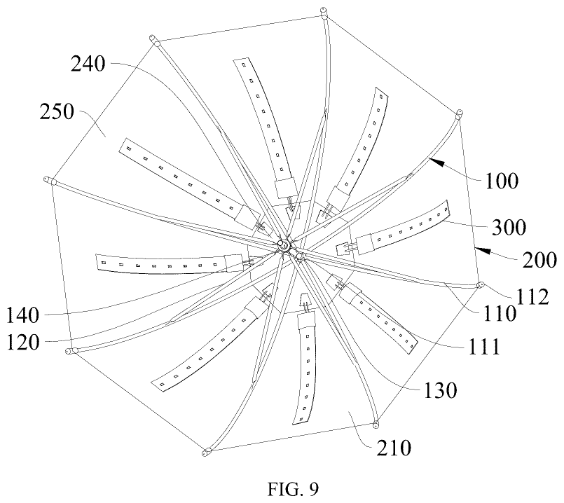

As shown in FIG. 9, in another embodiment, the softbox provided by the present disclosure includes a frame 100, a reflective fabric 200, a plurality of light-emitting components 300, and a support rod 400. The frame 100 supports the reflective fabric 200 to form a dome-shaped structure, and the plurality of light-emitting components 300 is fixed to the inner surface of the dome-shaped structure. The light emitted by the light-emitting components exits from an opening of the dome-shaped structure, which serves as the light-emitting opening. One end of the support rod 400 is connected to the frame 100, and the other end of the support rod 400 extends outward from the dome-shaped structure, away from the light-emitting opening, effectively preventing the support rod 400 from blocking the light.

In one embodiment, as shown in FIG. 6 and FIG. 9, the frame 100 includes an upper wheel 130 and a plurality of first rods 110. The plurality of first rods are arranged radially from the upper wheel 130 as a center. The length of the first rods 110 can be adaptively adjusted according to the size of the softbox. Each first rod 110 has a fixed end 111 and a free end 112. The free end 112 is arranged away from the upper wheel and the first rod 110 extending radially between the fixed end 111 and the free end 112.

The first rods 110 are elongated and flexible, and may be made of fiberglass or similar materials. In their natural state, the rods are straight. When the softbox is expanded, the first rods 110 bend due to tension from the reflective fabric 200, thereby shaping the fabric into a dome.

As shown in FIG. 9, in one embodiment, the fixed end 111 is hinged to the upper wheel 130, specifically by a wire passing through the fixed end (not shown in the figure), allowing the first rods 110 to rotate within a radial plane, so as to expand or fold the softbox.

To provide better support, in one embodiment, the frame 100 includes a lower wheel 140 and second rods 120. The second rods are shorter than the first rods 110 and made of the same material as the first rods 110. The two ends of each second rod 120 are hinged respectively to a corresponding first rod 110 and the lower wheel 140. A connector (not shown in the figure) that is connected to the second rod 120 is provided at the middle of each first rod 110, and the lower wheel 140 is provided with a wire (also not shown in the figure) passes through the end of the second rod 120.

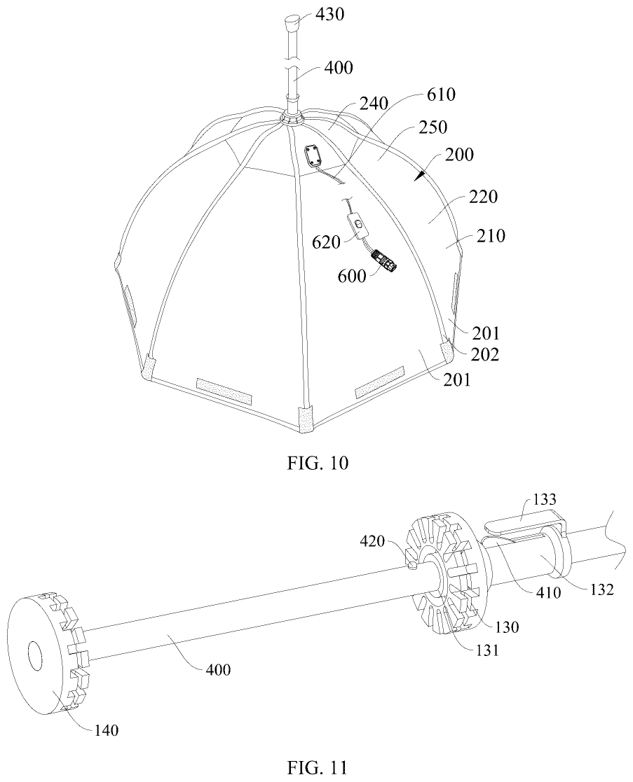

As shown in FIG. 10 and FIG. 11, one end of the support rod 400 is connected to the lower wheel 140, and the other end passes through the upper wheel 130 and extends to the outside of the dome-shaped structure, which serves to fix the softbox. A gripping member 430 is also provided at an end of the support rod.

As shown in FIG. 11, both the upper wheel 130 and the lower wheel 140 are disc-shaped structures. Their circumferential side walls are provided with notches that fit the corresponding rods and annular grooves to hold the wires. The upper wheel 130 has a through hole 131 for the support rod 400 and a sleeve 132 extending toward the back side of the light. A movable unlocking member 133 is disposed on the sleeve 132.

To expand the softbox, users may hold the support rod 400 and push the upper wheel 130 toward the lower wheel 140. The first rods 110 and the second rods 120 rotate away from the support rod 400, and the first rods 110 bend due to the tension from the reflective fabric 200, thus stretching the reflective fabric 200 into a dome. To fold the softbox, users may move the upper wheel 130 away from the lower wheel 140 along the support rod 400, so that the first rods 110 and second rods 120 rotate toward the support rod 400, and the first rods 110 return to their original shape, causing the entire softbox to fold up, which facilitates storage.

To keep the softbox in its expanded state, the support rod 400 is provided with a movable locking member 410. The locking member 410 includes a locking portion and an elastic portion. In the locked state, the locking portion protrudes from the support rod 400 under the force of the elastic portion, preventing the upper wheel 130 from moving away from the lower wheel 140. To release the lock, the locking member 410 is pressed so that the locking portion retracts into the support rod 400, allowing the upper wheel 130 to move along the support rod 400, thereby enabling the softbox to fold. This is a conventional structure and will not be described further here.

In one embodiment, as shown in FIG. 11, a limiting member 420 is provided on the support rod 400 to prevent the upper wheel 130 from moving further toward the lower wheel 140, thereby avoiding damage caused by over-expansion of the softbox.

The reflective fabric 200 is made of a flexible material and has an inner surface 210 and an outer surface 220. A reflective coating is applied to the inner surface 210 to form a mirror-like emission surface. The reflective fabric 200 is formed by splicing several fan-shaped units 201. The splicing seams are provided with overlapping edges 202, and a dome-like structure is formed when the cloth is expanded.

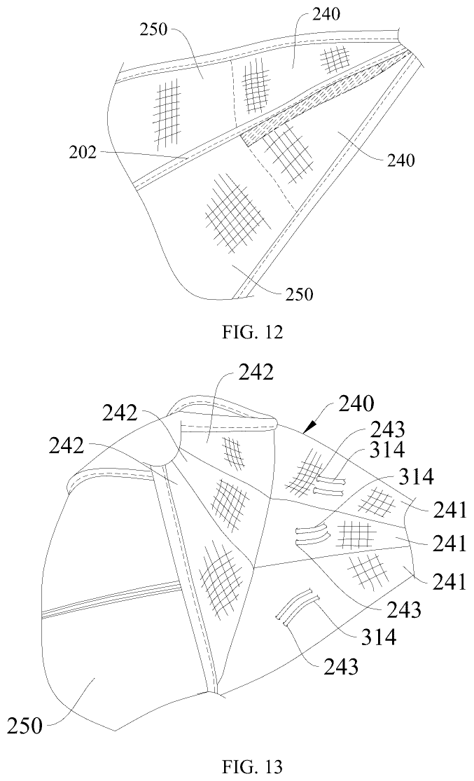

As shown in FIGS. 10 to 13, the reflective fabric 200 includes a central area 240 and a peripheral area 250 surrounding the central area 240. The central area 240 has a double-layer structure, including an inner layer 241 and an outer layer 242. The first wire 314 connected to the plurality of light-emitting components 300 is hidden in the interlayer between the two layers. The inner layer 241 of the central area 240 is provided with a perforation 243 for the wire to pass through.

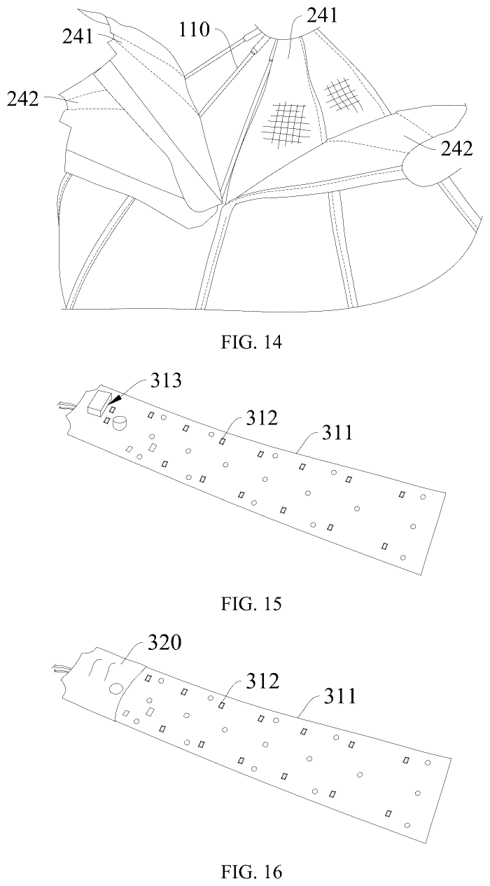

As shown in FIG. 14, a fixing member for securing the first rods 110 is provided on either the inner surface 210 or outer surface 220 of the reflective fabric 200. The fixing member may be a sleeve-like structure sewn from fabric or other forms such as stitching. It is generally located at the junction between two adjacent fan-shaped units 201. The inner surface 210 or outer surface 220 of the reflective fabric 200 may also be provided with Velcro to secure accessories such as diffusion cloth or grid. As shown in FIG. 17, in some embodiments, a diffusion cloth 800 is installed at the opening of the dome structure, which helps to make the emitted light more uniform and softer.

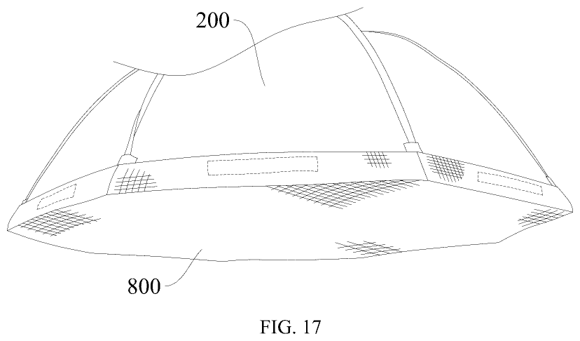

The light-emitting components 300 may be attached to the inner surface of the dome structure by adhesive. In some embodiments, as shown in FIGS. 15 and 16, each light-emitting component 300 includes a substrate 311 and a plurality of LED beads 312. The substrate 311 may be a metal substrate, such as an aluminum or copper substrate, with a white solder mask layer on the surface to enhance reflectivity.

In some embodiments, the substrate 311 is equipped with components forming a driving power source 313, which converts AC power to DC to power the LED beads. To improve reflectivity, each light-emitting component 300 includes a protective cover 320 that covers the driving power source 313. The protective cover 320 can be made of a flexible plastic sleeve. The driving power source 313 is typically located at one end of the substrate 311, and the plastic sleeve covers this end to prevent the components from being exposed. It is usually white in color.

Referring again to FIG. 10, the softbox also includes a plug 600 for connecting to an external power supply. A switch 620 is provided on the second wire 610 connected to the plug 600. The switch 620 controls the operation of the internal light-emitting components 300 in real-time. The second wire 610 acts as a bus that connects all the light-emitting components 300.

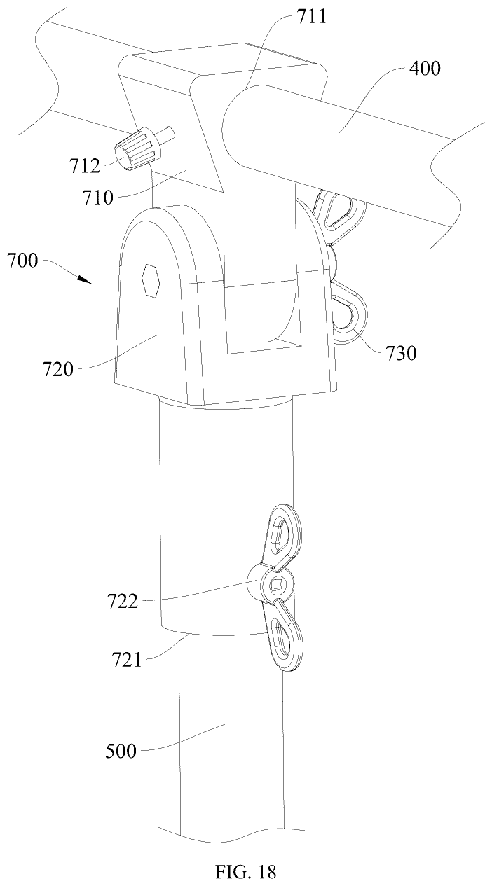

To adjust the position and the angle of the softbox, in one embodiment, as shown in FIG. 18, a connecting base 700 is provided on the support rod 400. The connecting base 700 includes a first part 710 and a second part 720 that are rotatably connected. The first part has a coupling hole 711 for mating with the support rod 400 and a first latching member 712 to secure the support rod 400. The coupling hole 711 is a through-hole through which the support rod 400 passes. The connecting base 700 is slidable relative to the support rod 400. The first latching member 712 fixes the connecting base 700 on the support rod 400.

The second part 720 has a blind hole 721 for mating with the stand 500 and a second latching member 722. A portion of the stand 500 is inserted into the blind hole 721 and secured by the second latching member 722 to prevent it from coming out.

The connecting base 700 is also equipped with a third latching member 730 that restricts the relative rotation between the two parts. Releasing the third latching member 730 allows adjustment of the tilt angle of the support rod 400 and thus the light-emitting angle of the softbox. By locking the third latching member 730, the light-emitting angle of the softbox is fixed.

The technical features of the above embodiments can be combined arbitrarily. For brevity, all possible combinations of the technical features in the above embodiments have not been described, but as long as there is no contradiction in the combinations, they should be considered within the scope of this specification. When technical features from different embodiments are shown in the same figure, the figure is deemed to disclose the combination of the involved embodiments.

The above embodiments are only several implementation modes of this disclosure. Their descriptions are relatively detailed and specific, but they should not be construed as limiting the scope of the patent disclosure. It should be noted that, for those skilled in the art, various modifications and improvements can be made without departing from the spirit of this disclosure, and these also fall within the protection scope of this disclosure.

What is claimed is:

1. A back-support softbox, having an expanded state and a folded state, the back-support softbox comprising:
a foldable frame, comprising a plurality of first rods, a plurality of second rods, an upper wheel, and a lower wheel, wherein each first rod has a fixed end and a free end, and the fixed end is hinged to the upper wheel; and wherein the plurality of second rods are provided in one-to-one correspondence with the plurality of first rods, one end of each second rod is hinged to a corresponding first rod, and an other end of each second rod is hinged to the lower wheel;
a flexible reflective fabric, having an inner surface and an outer surface and being attached to the plurality of first rods, wherein in the expanded state, the reflective fabric is stretched to form a dome-shaped structure;
a plurality of light-emitting components, provided on the inner surface of the reflective fabric; and
a support rod, one end of the support rod being fixedly connected to the lower wheel, an other end of the support rod passing through the upper wheel and extending to an outside of the dome-shaped structure,
wherein when the back-support softbox is transformed from the folded state to the expanded state, the upper wheel and the lower wheel move toward each other, and the plurality of first rods and the plurality of second rods rotate away from the support rod; and when the back-support softbox is transformed from the expanded state to the folded state, the upper wheel and the lower wheel move away from each other, and the plurality of first rods and the plurality of second rods rotate toward the support rod.

2. The back-support softbox according to claim 1, wherein each light-emitting component comprises a substrate and a plurality of LED beads mounted on the substrate.

3. The back-support softbox according to claim 2, wherein each substrate is strip-shaped and extends in a radial direction of the back-support softbox.

4. The back-support softbox according to claim 2, wherein each two adjacent first rods are formed with a fan-shaped region therebetween, and the fan-shaped region is provided with at least one of the plurality of light-emitting components.

5. The back-support softbox according to claim 2, wherein the substrate is provided with a driving power source.

6. The back-support softbox according to claim 5, further comprising a plurality of protective covers, wherein each driving power source is cover by one of the plurality of protective covers.

7. The back-support softbox according to claim 1, wherein a plug is provided on the outside of the dome-shaped structure, and the plug is electrically connected to the plurality of light-emitting components.

8. The back-support softbox according to claim 7, wherein a switch is provided on a wire connecting the plug and the plurality of light-emitting components.

9. The back-support softbox according to claim 1, wherein a locking member is provided on the support rod for locking the frame to maintain the back-support softbox in the expanded state.

10. The back-support softbox according to claim 1, wherein a limiting member is provided on the support rod for restricting movement of the upper wheel to prevent the dome-shaped structure from over-expanding.

11. The back-support softbox according to claim 1, wherein a gripping member is provided at an end of the support rod.

12. The back-support softbox according to claim 1, further comprising a connecting base mounted on the support rod.

13. The back-support softbox according to claim 1, further comprising a diffusion cloth or a grid mounted at an opening of the dome-shaped structure.

14. The back-support softbox according to claim 1, wherein the reflective fabric comprises a central area and a peripheral area surrounding the central area, the central area has a double-layered structure, and a wire connected to the plurality of light-emitting components is hidden within an interlayer of the double-layered structure.

15. The back-support softbox according to claim 1, wherein the back-support softbox has a central axis, and the support rod is arranged along the central axis.

16. A softbox, comprising:
a frame, comprising an upper wheel and a plurality of first rods, the plurality of first rods being arranged radially from the upper wheel as a center;
a reflective fabric, the reflective fabric being attached to the plurality of first rods and stretched to form a dome-shaped structure, the dome-shaped structure having an inner surface and an outer surface;
a plurality of light-emitting components, provided on the inner surface of the dome-shaped structure; and
a support rod, wherein one end of the support rod is connected to the frame, and an other end of the support rod extends away from a light-emitting opening of the dome-shaped structure to an outside of the dome-shaped structure.

17. The softbox according to claim 16, wherein each first rod has a fixed end and a free end, the fixed end is hinged to the upper wheel, and the free end is away from the upper wheel;
wherein the frame further comprises a lower wheel and a plurality of second rods, the one end of the support rod is connected to the lower wheel, and the other end of the support rod passes through the upper wheel; and wherein the plurality of second rods are provided in one-to-one correspondence with the plurality of first rods, one end of each second rod is hinged to a corresponding first rod, and an other end of each second rod is connected to the lower wheel.

18. A photographic auxiliary device, comprising a stand and the softbox according to claim 16 mounted on the stand, wherein the support rod is connected to the stand.

19. The photographic auxiliary device according to claim 18, wherein the support rod is arranged horizontally, and a back side of a light-emitting opening of the dome-shaped structure faces the stand.

20. The photographic auxiliary device according to claim 18, wherein the support rod is provided with a connecting base for connecting to the stand, and the connecting base is slidable relative to the support rod.
